(19) United States
(12) Patent Application Publication
(10) Pub. No.: US 2011/0139105 A1
(43) Pub. Date: Jun. 16, 2011

(54) Variable Valve Timing Control Apparatus Cover and Method for Producing the Cover

(75) Inventors: Kotaro WATANABE, Atsugi-shi (JP); Takeshi Watanabe, Atsugi-shi (JP)

(73) Assignee: Hitachi Automotive Systems, Ltd., Hitachinaka-shi (JP)

(21) Appl. No.: 12/966,372

(22) Filed: Dec. 13, 2010

(30) Foreign Application Priority Data
Dec. 15, 2009 (JP) 2009-283641

(51) Int. Cl. F02F 7/00; B23P 17/00

(52) U.S. Cl. 123/90.38; 29/527.5

(57) ABSTRACT

A variable valve timing control apparatus (VTC) cover is a cover that covers both intake side and exhaust side VTCs respectively controlling valve timing of an intake valve and an exhaust valve by supplying/drawing of oil. The intake side and exhaust side VTCs are arranged parallel to each other and close to each other and installed to an internal combustion engine. The VTC cover has a first cover unit having a first supplying/drawing rod inserted into a rod connecting hole of one of the intake side and exhaust side VTCs to supplies/draws the oil and a second cover unit having a second supplying/drawing rod inserted into a rod connecting hole of the other of the intake side and exhaust side VTCs to supplies/draws the oil. The VTC cover is formed by fixing the second cover unit to the first cover unit.

### BACKGROUND OF THE INVENTION

The present invention relates to improvement of a cover used for a variable valve timing control apparatus that variably controls open/close timing of an intake valve and an exhaust valve of an internal combustion engine in accordance with an engine operating state.

As a related art variable valve timing control apparatus, for example, it has been disclosed in Japanese Patent Provisional Publication No. 2005-61261 (hereinafter is referred to as “JP2005-061261”).

In JP2005-061261, a variable valve timing control apparatus is provided for each of an intake valve and an exhaust valve. One end sides of these intake side and exhaust side variable valve timing control apparatuses are covered with a cover that is formed integrally from an intake valve side to an exhaust valve side. Then, oil is supplied to and drawn from each variable valve timing control apparatus through the cover. More specifically, the cover has two supplying/drawing rods which are formed integrally with the cover. One of the rods is inserted into a connecting hole of the intake side variable valve timing control apparatus, and the other of the rods is inserted into a connecting hole of the exhaust side variable valve timing control apparatus. The oil is then supplied to and drawn from each of the intake side variable valve timing control apparatus and the exhaust side variable valve timing control apparatus through their respective supplying/drawing rods.

### SUMMARY OF THE INVENTION

Here, with regard to the cover, in a case where the cover is cast in aluminum alloy material, since the supplying/drawing rod has a certain axial length, if sufficient pressurization is not done upon the casting, a cavity appears in an inside of the supplying/drawing rod. Further, in a case where the both supplying/drawing rods of the intake side and exhaust side variable valve timing control apparatuses are arranged close to and parallel to each other, since a sufficient pressure-receiving area of a piston that pressurizes a portion of each supplying/drawing rod is not be able to be secured, there is a problem that the appearance of the cavity is not prevented.

The present invention focuses attention on this problem, and an object of the present invention is to provide a variable valve timing control apparatus cover in which the appearance of the cavity can be adequately suppressed even in the case where the supplying/drawing rods are arranged close to each other.

According to one aspect of the present invention, a variable valve timing control apparatus (VTC) cover for covering both intake side and exhaust side VTCs respectively controlling valve timing of an intake valve and an exhaust valve by supplying/drawing of oil, the intake side and exhaust side VTCs arranged parallel to each other and installed to an internal combustion engine, the VTC cover comprises: a first cover unit having a first supplying/drawing rod inserted into a rod connecting hole of one of the intake side and exhaust side VTCs to supplies/draws the oil; and a second cover unit having a second supplying/drawing rod inserted into a rod connecting hole of the other of the intake side and exhaust side VTCs to supplies/draws the oil, and the VTC cover is formed by fixing the second cover unit to the first cover unit.

According to another aspect of the present invention, a method for producing a variable valve timing control apparatus (VTC) cover for covering both intake side and exhaust side VTCs respectively controlling valve timing of an intake valve and an exhaust valve by supplying/drawing of oil through first and second supplying/drawing rods, the intake side and exhaust side VTCs arranged parallel to each other and installed to an internal combustion engine, the method comprises: a first process in which a first cover unit is molded by pressurizing a top portion of the first supplying/drawing rod through a die casting; a second process in which a second cover unit is molded by pressurizing a top portion of the second supplying/drawing rod through a die casting; and a third process in which the second cover unit is fixed to the first cover unit.

The other objects and features of this invention will become understood from the following description with reference to the accompanying drawings.

### BRIEF DESCRIPTION OF THE DRAWINGS

FIG. 1 is a sectional view taken along an A-A line in FIG. 2, of a variable valve timing control apparatus (VTC) according to an embodiment of the present invention.

FIG. 2 is a schematic front view of the variable valve timing control apparatus (VTC) with a variable valve timing control apparatus cover (VTC cover) removed.

FIG. 3 is a drawing showing an inside structure of an intake side variable valve timing control apparatus (intake side VTC) of FIG. 1.

FIG. 4 is a drawing showing an inside structure of an exhaust side variable valve timing control apparatus (exhaust side VTC) of FIG. 1.

FIG. 5 is a perspective exploded view of the variable valve timing control apparatus cover (VTC cover), viewed from outside.

FIG. 6 is a perspective exploded view of the variable valve timing control apparatus cover (VTC cover), viewed from inside.

FIG. 7 is a front view of the variable valve timing control apparatus cover (VTC cover).

FIG. 8 is a back view of the variable valve timing control apparatus cover (VTC cover).

FIG. 9 is an enlarged sectional view of a top end side portion of an intake side supplying/drawing rod.

FIG. 10 is an enlarged sectional view of a top end side portion of an intake side supplying/drawing rod of a related art variable valve timing control apparatus cover (related art VTC cover).

FIG. 11 is a schematic view used for explaining a producing method of a second cover unit.

### DETAILED DESCRIPTION OF THE INVENTION

Embodiments of a variable valve timing control apparatus cover of the present invention will be explained below with reference to the drawings.

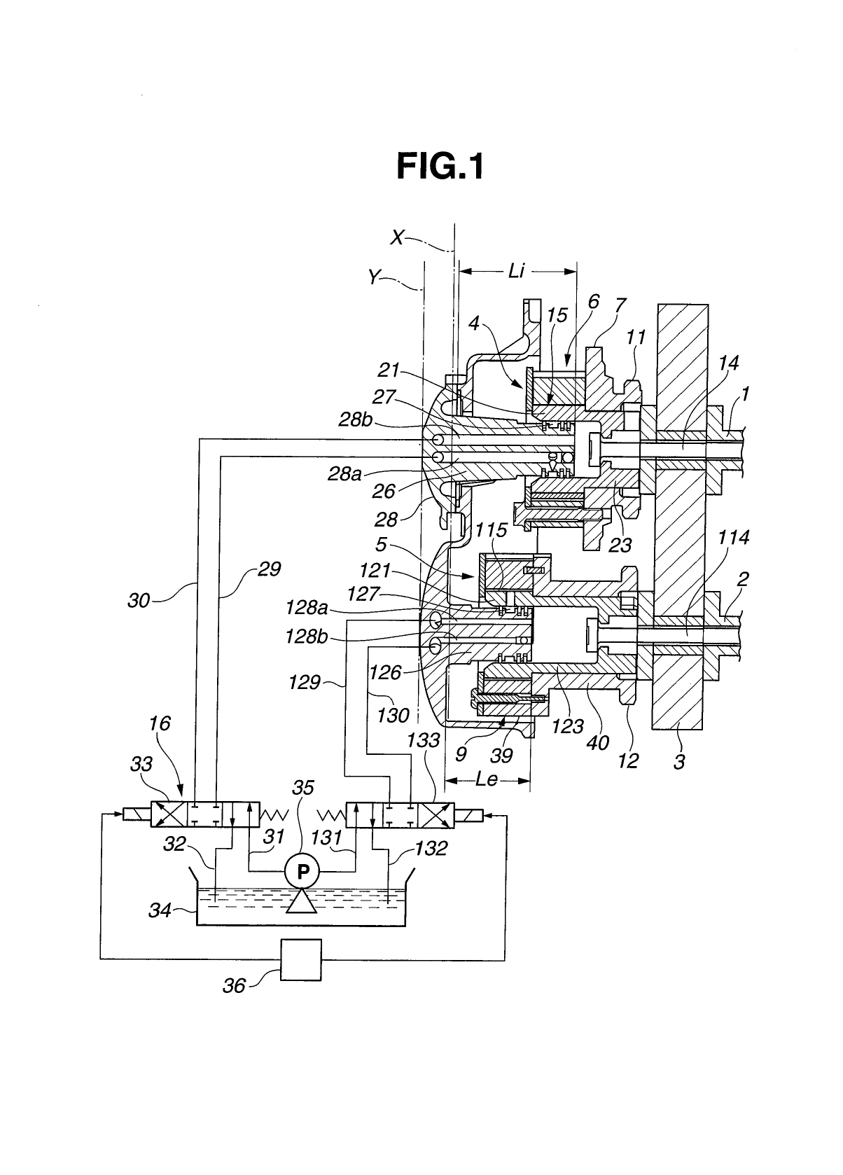

First, a variable valve timing control apparatus (hereinafter called VTC) to which a variable valve timing control apparatus cover (hereinafter called VTC cover) is attached will be explained. As shown in FIG. 1, an intake side camshaft 1 which is fixedly provided with a drive cam (not shown) and opens/closes an intake valve by rotation of the camshaft through the drive cam and an exhaust side camshaft 2 which is fixedly provided with a drive cam (not shown) and opens/closes an exhaust valve by rotation of the camshaft through the drive cam, are rotatably supported in a cylinder block 3 of an internal combustion engine. On each front end portion of the camshafts 1 and 2, an intake side VTC 4 that varies a phase of the intake side camshaft 1 and an exhaust side VTC 5 that varies a phase of the exhaust side camshaft 2 are installed.

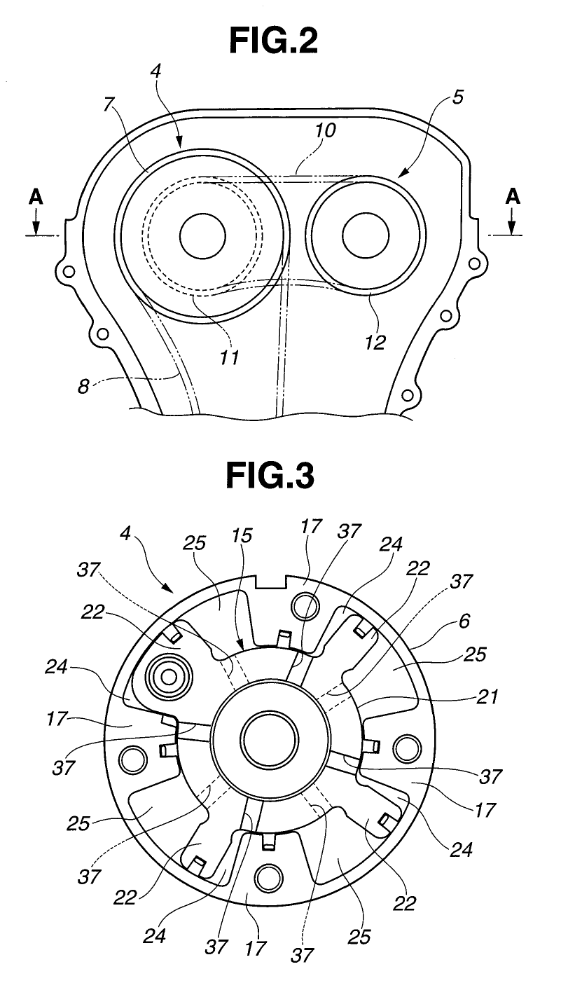

As shown in FIG. 2, these VTCs 4 and 5 control a relative rotation phase of each of the intake side and exhaust side camshafts 1 and 2 to an engine crankshaft (not shown) in accordance with an engine operating state. A drive input sprocket 7 is set at an outer circumference portion of an intake side housing 6 of the intake side VTC 4. A chain 8 is wound around the drive input sprocket 7, and the drive input sprocket 7 is linked to the engine crankshaft via the chain 8. A rotation driving force of the engine crankshaft is then transmitted to the intake side camshaft 1 via the chain 8.

Here, with respect to the drive input sprocket 7, it rotates in a rotation ratio of ½ of a sprocket of the engine crankshaft. Thus an outside diameter of the drive input sprocket 7 is set so that the number of teeth of the drive input sprocket 7 is double that of the sprocket of the engine crankshaft.

In the both VTCs 4 and 5, the intake side camshaft 1 and the exhaust side camshaft 2 are arranged parallel to each other and also close to each other. As can be seen in FIG. 1, a drive output sprocket 11 is set parallel to the drive input sprocket 7 at the outer circumference portion of the intake side housing 6 of the intake side VTC 4. A drive input sprocket 12 is set at an outer circumference portion of an exhaust side housing 9 of the exhaust side VTC 5. A chain 10 is wound between the drive output sprocket 11 and the drive input sprocket 12. The intake side camshaft 1 and the exhaust side camshaft 2 are linked to each other via the chain 10, the rotation driving force of the engine crankshaft is then transmitted to the exhaust side camshaft 2 via the chain 10.

Each of the VTCs 4 and 5 is configured so that its rotation is controlled by hydraulic pressure. Both basic configurations are almost the same.

The intake side VTC 4 will be explained first. The intake side VTC 4 mainly has the intake side housing 6, where the drive input sprocket 7 and the drive output sprocket 11 are arranged in series in an axial direction at the outer circumference portion of the intake side housing 6, a vane rotor 15 and a hydraulic pressure supplying/drawing system 16 that supplies and draws oil to and from the intake side VTC 4 to relatively rotate the vane rotor 15 with respect to the intake side housing 6 in accordance with the engine operating state. The vane rotor 15 is installed at an inner circumferential side of the intake side housing 6 so that the vane rotor 15 can relatively rotate with respect to the intake side housing 6, and is connected to the front end portion of the intake side camshaft 1 with a cam bolt 14.

With regard to the intake side housing 6, as can be seen in FIG. 3, on an inner circumference surface of a circumference wall of the intake side housing 6, four partition walls 17 are arranged at substantially regular intervals in a circumferential direction. More specifically, each partition wall 17 protrudes inwards in a radial direction, and a cross section of the partition wall 17 is almost trapezoidal shape.

On the other hand, on the rear end side outer circumference portion of the circumference wall of the intake side housing 6, as shown in FIG. 1, the drive input sprocket 7 and the drive output sprocket 11 are provided at a certain interval in the axial direction.

The vane rotor 15 is installed in an inner circumferential side center of the intake side housing 6. The vane rotor 15 has a cylindrical base portion 21 whose outer circumference surface makes sliding contact with a top end part of the partition wall 17, four vanes 22 protruding outwards in the radial direction from an outer circumference portion of the base portion 21 and a stem portion 23 extending from a rear end portion of the base portion 21 in the axial direction. The vane rotor 15 is connected to the intake side camshaft 1 with the vane rotor 15 penetrating the intake side housing 6 so that each vane 22 is disposed between the adjacent partition walls 17 of the intake side housing 6. The vane rotor 15 serves to rotatably support the intake side housing 6 at the penetration part.

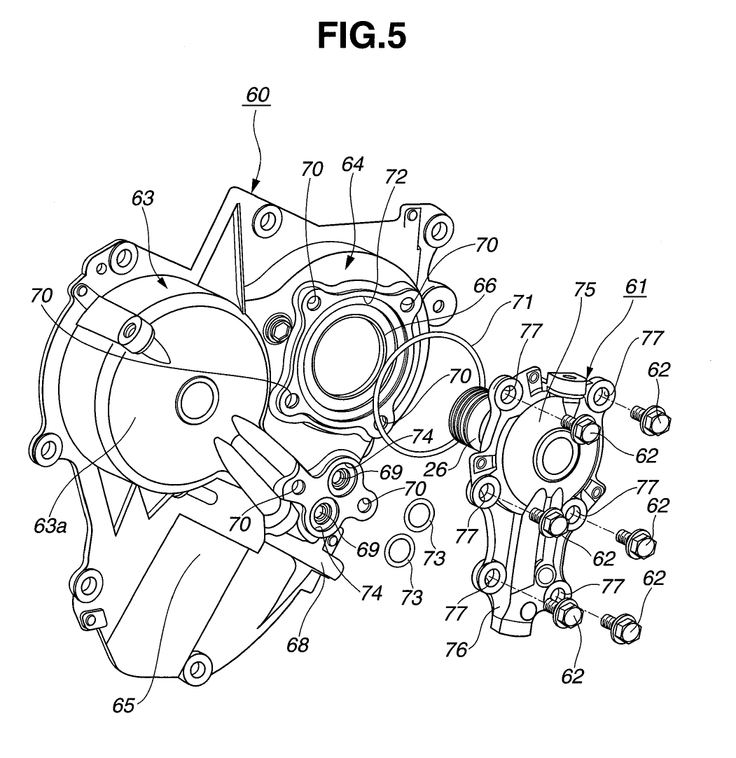

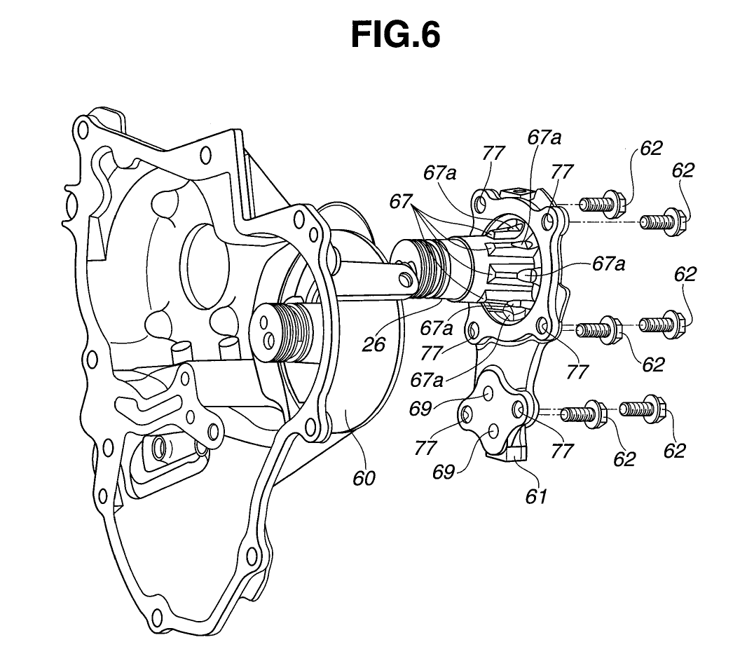

As shown in FIG. 1, an intake side rod connecting hole 27 receiving therein an intake side supplying/drawing rod (a second supplying/drawing rod) 26 is provided in a front end side axial center of the vane rotor 15. The intake side supplying/drawing rod 26 (see FIGS. 5 and 6) is provided so as to protrude inwards from an inner side portion of a second cover unit 61 of a VTC cover 28, and is rotatably inserted and fitted into the intake side rod connecting hole 27.

Further, the base portion 21 of the vane rotor 15 is provided with eight oil holes 37. The oil hole 37 radially penetrates the base portion 21 so that its one end opens to the intake side rod connecting hole 27 and the other end opens to an advance chamber 24 or a retard chamber 25 which are defined at both sides of the vane 22 between the adjacent partition walls 17. With this configuration, in the intake side VTC 4, the oil is supplied to and drawn from the advance chamber 24 and the retard chamber 25 via the intake side rod connecting hole 27 and the oil holes 37 by the hydraulic pressure supplying/drawing system 16.

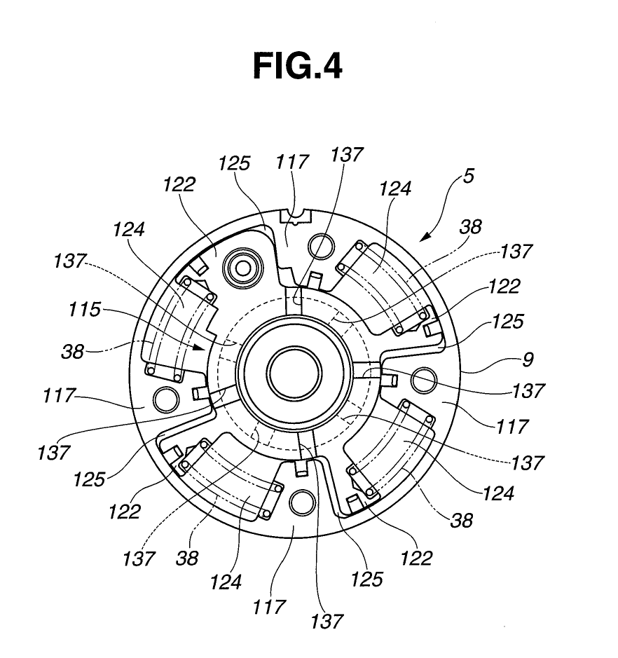

The hydraulic pressure supplying/drawing system 16 has first and second hydraulic pressure passages 29 and 30 that supply and draw the oil to and from the advance chamber 24 and the retard chamber 25 of the intake side VTC 4, third and fourth hydraulic pressure passages 129 and 130 that supply and draw the oil to and from an advance chamber 124 and a retard chamber 125 (see FIG. 4) of the exhaust side VTC 5, an intake side electromagnetic valve 33 that sets the first and second hydraulic pressure passages 29 and 30 to any one of a supply passage 31, a drain passage 32 or a holding position, and an exhaust side electromagnetic valve 133 that sets the third and fourth hydraulic pressure passages 129 and 130 to any one of a supply passage 131, a drain passage 132 or a holding position. In FIG. 1, a reference sign 35 indicates an oil pump, a reference sign 36 indicates a controller to control the electromagnetic valves 33 and 133.

On the other hand, the exhaust side VTC 5 mainly has the exhaust side housing 9, where the drive input sprocket 12 is set at the rear end side outer circumference portion of the exhaust side housing 9, a vane rotor 115, a compression spring 38 (see FIG. 4) that forces the vane rotor 115 towards an advance direction and the hydraulic pressure supplying/drawing system 16 (same as the system 16 used for the intake side VTC 4) that supplies and draws the oil to and from the exhaust side VTC 5 to relatively rotate the vane rotor 115 with respect to the exhaust side housing 9 in accordance with the engine operating state. The vane rotor 115 is installed at an inner circumferential side of the exhaust side housing 9 so that the vane rotor 115 can relatively rotate with respect to the exhaust side housing 9, and is connected to the front end portion of the exhaust side camshaft 2 with a cam bolt 14.

As can be seen in FIGS. 1 and 4, the exhaust side housing 9 mainly has a housing main body 39 that houses each vane 122 of the vane rotor 115 and a transmission block 40. The transmission block 40 is fixed to a rear end portion of the housing main body 39 so as to integrally rotate with the housing main body 39, and the drive input sprocket 12 is set at the rear end side outer circumference portion of the transmission block 40.

On an inner circumference surface of a circumference wall of the housing main body 39, four partition walls 117 are arranged at regular intervals in a circumferential direction. More specifically, each partition wall 117 protrudes inwards in a radial direction, and a cross section of the partition wall 117 is almost trapezoidal shape. The advance chamber 124 and the retard chamber 125 are then defined at both sides of the vane 122 of the vane rotor 115 between the adjacent partition walls 117.

The vane rotor 115 is installed in an inner circumferential side center of the housing main body 39. The vane rotor 115 has a cylindrical base portion 121 whose outer circumference surface makes sliding contact with a top end part of the partition wall 117, four vanes 22 protruding outwards in the radial direction from an outer circumference portion of the base portion 121 and a stem portion 123 extending from a rear end portion of the base portion 121 in the axial direction. The vane rotor 115 is connected to the exhaust side camshaft 2 with the vane rotor 115 penetrating the exhaust side housing 9 so that each vane 122 is disposed between the adjacent partition walls 117 of the housing main body 39. The vane rotor 115 serves to rotatably support the exhaust side housing 9 at the penetration part.

As shown in FIG. 1, an exhaust side rod connecting hole 127 receiving therein an exhaust side supplying/drawing rod (a first supplying/drawing rod) 126 is provided in a front end side axial center of the vane rotor 115. The exhaust side supplying/drawing rod 126 is provided so as to protrude inwards from an inner side portion of a first cover unit 60 of the VTC cover 28, and is rotatably inserted and fitted into the exhaust side rod connecting hole 127.

Further, the base portion 121 of the vane rotor 115 is provided with eight oil holes 137. The oil hole 137 radially penetrates the base portion 121 so that its one end opens to the exhaust side rod connecting hole 127 and the other end opens to the advance chamber 124 or the retard chamber 25 which are defined at both sides of the vane 122 between the adjacent partition walls 117. With this configuration, in the exhaust side VTC 5, the oil is supplied to and drawn from the advance chamber 124 and the retard chamber 125 via the exhaust side rod connecting hole 127 and the oil holes 137 by the hydraulic pressure supplying/drawing system 16.

With respect to the VTC cover 28, as shown in FIGS. 5 and 6, the VTC cover 28 mainly has the first cover unit 60 and the second cover unit 61, each of which is separately formed. The first cover unit 60 is formed so as to cover the exhaust side VTC 5 and also widely cover the both VTCs 4 and 5 by extending up to the intake side VTC 4. The second cover unit 61 is formed so as to cover the intake side VTC 4 together with the first cover unit 60. The second cover unit 61 is fixed to the first cover unit 60 that is a base body of the VTC cover 28, and the first cover unit 60 is secured to a chain case opening portion of an engine block (both not shown).

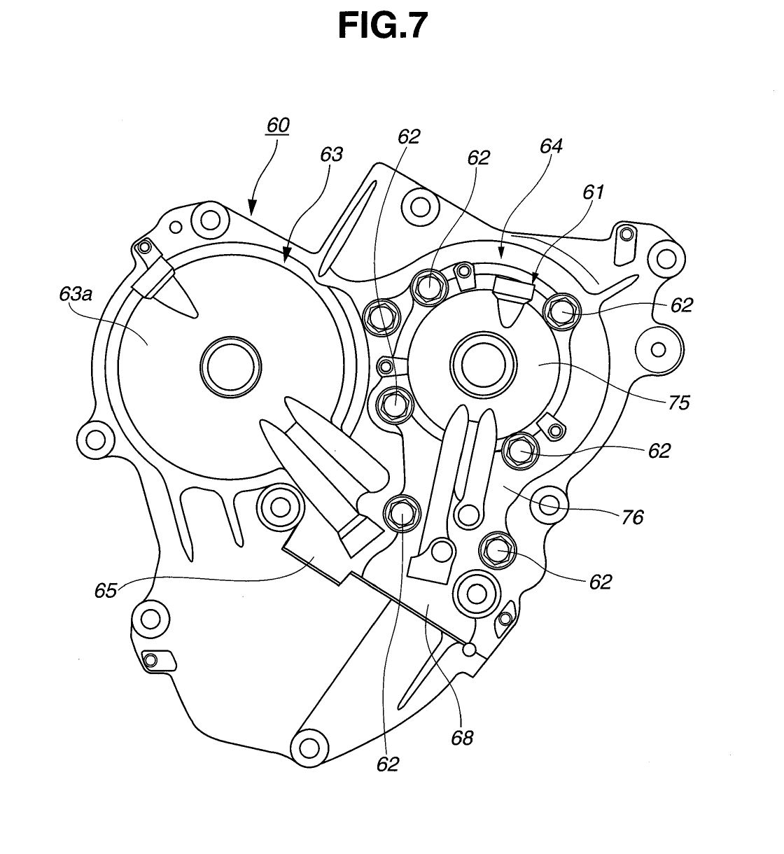

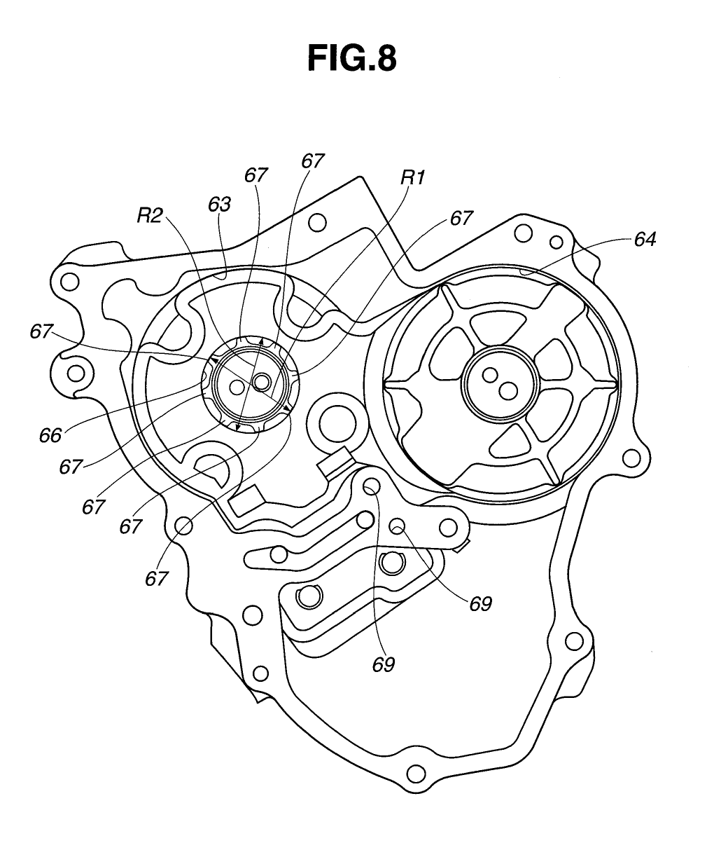

As seen in the drawings, the second cover unit 61 is fixedly connected to the first cover unit 60 with six bolts 62, then a combined unit (see FIGS. 7 and 8) as the VTC cover 28 is secured to the chain case opening portion with a plurality of bolts (not shown).

By employing these configurations, the VTC cover 28 can be secured to the chain case opening portion with the VTC cover 28 separated into the first cover unit 60 and the second cover unit 61, thereby improving the installation of the VTC cover 28. Further, since the second cover unit 61 is fixed to the first cover unit 60 with the bolts 62, the first cover unit 60 and the second cover unit 61 can be detached from each other, also can be firmly fixed to each other.

The first cover unit 60 is cast in aluminum alloy material (by die casting) and is formed into a desired shape that fits the chain case opening portion. The first cover unit 60 has a substantially bottomed or lidded cylindrical exhaust side VTC housing part 63 and a substantially cylindrical intake side VTC housing part 64. The exhaust side VTC housing part 63 is formed so as to cover almost all of the exhaust side VTC 5. The intake side VTC housing part 64 is arranged close to the exhaust side VTC housing part 63 and is formed so as to cover an outer circumference portion of the intake side VTC 4.

The exhaust side VTC housing part 63 has a cover portion 63a that covers a front surface of the exhaust side VTC 5. The substantially cylindrical column shaped exhaust side supplying/drawing rod 126 inserted and fitted into the exhaust side rod connecting hole 127 is provided on an inner side surface of the cover portion 63a so as to protrude in an axial direction of the exhaust side VTC housing part 63.

The exhaust side supplying/drawing rod 126 has therein a pair of oil passages 128a and 128b, one ends of which communicate with the advance chamber 124 and the retard chamber 125 via the oil hole 137 and the other ends of which communicate with the third and fourth hydraulic pressure passages 129 and 130. The oil passages 128a and 128b extend in a protruding direction of the exhaust side supplying/drawing rod 126 inside the exhaust side supplying/drawing rod 126.

Here, the third and fourth hydraulic pressure passages 129 and 130 are provided so as to be placed substantially along a radial direction of the exhaust side VTC housing part 63. The third and fourth hydraulic pressure passages 129 and 130 are, at an inside of the first cover unit 60, connected to the exhaust side electromagnetic valve 133 that is attached to an exhaust side electromagnetic valve housing part 65 provided at an outer side portion of the exhaust side VTC housing part 63. On a top end side outer circumference surface of the exhaust side supplying/drawing rod 126, three seal holding grooves to which three sealing members are fitted in series are formed by cutting. Since these structures are the same as those of the intake side supplying/drawing rod 26, they will be explained later in an explanation about the intake side supplying/drawing rod 26.

As shown in FIG. 1, the exhaust side supplying/drawing rod 126 is set so that its axial length Le is shorter than an axial length Li of the intake side supplying/drawing rod 26. As explained above, in the VTCs 4 and 5, in order that the drive output sprocket 11 of the intake side VTC 4 and the drive input sprocket 12 of the exhaust side VTC 5 are linked with each other through the chain 10, these drive output sprocket 11 and the drive input sprocket 12 are required to be arranged so as to face to each other. Further, in the intake side VTC 4, the drive input sprocket 7 linking with the engine crankshaft is provided in the middle of the intake side VTC 4. Because of these configuration and linkage, in the case where both the VTCs 4 and 5 are arranged close to each other like the present embodiment, the exhaust side VTC 5 is set with the exhaust side VTC 5 shifting towards the VTC cover 28 with respect to the intake side VTC 4. That is, the exhaust side VTC 5 is offset with respect to the intake side VTC 4. This offset arrangement prevents interference or contact between the drive input sprocket 7 of the intake side VTC 4 and the exhaust side housing 9 of the exhaust side VTC 5. The axial length of the exhaust side supplying/drawing rod 126 can be set to be shorter than that of the intake side supplying/drawing rod 26 by a length equivalent to an offset amount of the exhaust side VTC 5 towards the VTC cover 28.

As can be seen in FIGS. 1, 5 and 6, the intake side VTC housing part 64 is provided with a rod insertion hole 66 into which the intake side supplying/drawing rod 26 formed same as the exhaust side supplying/drawing rod 126 is inserted. The rod insertion hole 66 is placed in an opposed position to the intake side rod connecting hole 27 upon the installation of the VTC cover 28.

As shown in FIGS. 6 and 8, a diameter of the rod insertion hole 66 is set to be slightly larger than an outside diameter R1 of a maximum diameter part that is formed by a plurality of protruding portions 67 arranged around an outer circumference portion of a base end side of the intake side supplying/drawing rod 26. Also an inside diameter R2 of the rod insertion hole 66 is set so that positioning in a radial direction of the intake side supplying/drawing rod 26 with respect to the rod insertion hole 66 by the maximum diameter part can be achieved. With this setting, the base end side of the intake side supplying/drawing rod 26 is fitted to the rod insertion hole 66 in a centered-position without distortion of the intake side supplying/drawing rod 26 and the rod insertion hole 66.

Further, because of the offset arrangement of the exhaust side VTC 5 with respect to the intake side VTC 4, a height (an axial direction protrusion amount) of the intake side VTC housing part 64 is set to be slightly lower than that of the exhaust side VTC housing part 63. That is, the intake side VTC housing part 64 is formed so that, with consideration given to a thickness of an after-mentioned cover part 75 of the second cover unit 61, a thickness of the intake side VTC housing part 64 is smaller than that of the exhaust side VTC housing part 63 by the thickness of the cover part 75. With this setting, as shown by a dashed line X in FIG. 1, the intake side supplying/drawing rod 26 and the exhaust side supplying/drawing rod 126 are set so that positions in the axial direction of both base end portions are substantially the same. As a consequence, as shown by a dashed line Y in FIG. 1, positions of both outermost portions of the first and second cover units 60 and 61 are set to be the same in the axial direction. By employing these configurations, it is possible to prevent an unnecessarily large uneven part from being formed on an outside of the VTC cover 28. This allows an improvement in layout design of the internal combustion engine.

The first cover unit 60 has an intake side electromagnetic valve housing part 68 which is formed at an outer side portion of the first cover unit 60 and to which the intake side electromagnetic valve 33 is attached and a pair of connecting holes 69 that connect the first and second hydraulic pressure passages 29 and 30 provided at the second cover unit 61 and the intake side electromagnetic valve 33. That is, the first and second hydraulic pressure passages 29 and 30 and the intake side electromagnetic valve 33 are connected through the connecting holes 69. With this configuration, the oil is supplied to and drawn from the intake side VTC 4.

Furthermore, as shown in FIG. 5, the first cover unit 60 is provided with screw holes 70 into which the bolts 62 are screwed around the rod insertion hole 66 and at both sides of the connecting holes 69. The bolts 62 are screwed into the screw holes 70 through bolt insertion holes 77 that are formed at the second cover unit 61, thereby fixing the second cover unit 61 to the first cover unit 60.

Here, a seal holding groove 72 is formed at an outer circumference of the rod insertion hole 66 by cutting, and the seal holding groove 72 receives therein a ring shaped sealing member 71 made of so-called fluorocarbon rubber. Upon the fixing of the second cover unit 61 to the first cover unit 60, the sealing member 71 is fitted in a connecting gap between the both cover units 60 and 61. With this, liquid-tightness of the connecting gap between the both cover units 60 and 61 is ensured, and oil leakage from the connecting gap can be suppressed.

Likewise, as for the connecting hole 69, a seal holding groove 74 is formed at an outer circumference of each connecting hole 69 by cutting, and the seal holding groove 74 receives therein a ring shaped sealing member 73 made of so-called fluorocarbon rubber. Upon the fixing of the second cover unit 61 to the first cover unit 60, each sealing member 73 is fitted in a connecting gap between the both cover units 60 and 61. With this, liquid-tightness of the connecting gap between the both cover units 60 and 61 is ensured, and oil leakage from the connecting gap can be suppressed.

On the other hand, the second cover unit 61 is cast in aluminum alloy material (by die casting) and is formed into a substantially plate shape, same as the die casting of the first cover unit 60. The second cover unit 61 is formed so as to close the rod insertion hole 66 of the first cover unit 60. The second cover unit 61 has a cover portion 75 that covers a front surface of the intake side VTC 4 and an oil passage section 76 that forms the first and second hydraulic pressure passages 29 and 30 extending along a radial direction from the cover portion 75. The bolt insertion holes 77 into which the bolts 62 are inserted are provided around the cover portion 75.

The substantially cylindrical column shaped intake side supplying/drawing rod 26 inserted and fitted into the intake side rod connecting hole 27 is provided at an inner side surface of the cover portion 75 so as to protrude along a thickness direction of the second cover unit 61 with the intake side supplying/drawing rod 26 being perpendicular to the inner side surface of the cover portion 75.

The intake side supplying/drawing rod 26 has therein a pair of oil passages 28a and 28b, one ends of which communicate with the advance chamber 24 and the retard chamber 25 via the oil hole 37 and the other ends of which communicate with the first and second hydraulic pressure passages 29 and 30. The oil passages 28a and 28b extend in a protruding direction of the intake side supplying/drawing rod 26 inside the intake side supplying/drawing rod 26.

Here, the first and second hydraulic pressure passages 29 and 30 are formed inside the oil passage section 76 so that upstream side end portions of the first and second hydraulic pressure passages 29 and 30 open to an inner side surface of the second cover unit 61. Upon the fixing of the second cover unit 61 to the first cover unit 60, the upstream side end portions of the first and second hydraulic pressure passages 29 and 30 are connected to the connecting holes 69. The first and second hydraulic pressure passages 29 and 30 are therefore, at the inside of the first cover unit 60, connected to the intake side electromagnetic valve 33 attached to the intake side electromagnetic valve housing part 68 through the connecting holes 69.

As shown in FIG. 6, the intake side supplying/drawing rod 26 is formed so that its base end side has conical and reverse-tapered shape. Further, the intake side supplying/drawing rod 26 is provided with, at its base end side outer circumference portion, a positioning means (a positioning structure or mechanism) that achieves the positioning in the radial direction of the intake side supplying/drawing rod 26 with respect to the rod insertion hole 66 by making contact (sliding contact) with an inner circumference surface of the rod insertion hole 66. More specifically, this positioning means is formed by the eight protruding portions 67 arranged at substantially regular intervals around the base end side outer circumference portion of the intake side supplying/drawing rod 26. The protruding portion 67 radially protrudes, and has an almost trapezoidal shape in cross section.

Since these protruding portions 67 are formed together at the same time by flow of the material (molten metal) upon the casting, increase in man-hour of working (metalworking) for the positioning can be suppressed, and the positioning can be easily achieved. In addition, since the positioning means is formed by the eight protruding portions 67, exact and stable positioning of the intake side supplying/drawing rod 26 can be achieved.

Furthermore, as can be seen in FIG. 6, the protruding portion 67 is provided with a guide surface 67a in a predetermined area in the axial direction of a top roof portion of the protruding portion 67 through a cutting process. The guide surface 67a is formed at least the predetermined area on the top roof portion which touches or makes contact with the inner circumference surface of the rod insertion hole 66. The guide surface 67a serves to guide the intake side supplying/drawing rod 26 to be inserted into the rod insertion hole 66 by touching or making contact with the inner circumference surface of the rod insertion hole 66. These guide surfaces 67a are formed through the cutting process after the casting of the second cover unit 61, namely that each of the guide surfaces 67a is formed by cutting the top roof portion of the almost trapezoidal-shaped protruding portion 67. Thus the top roof portion has a large area in comparison with the top roof portion before the cutting process.

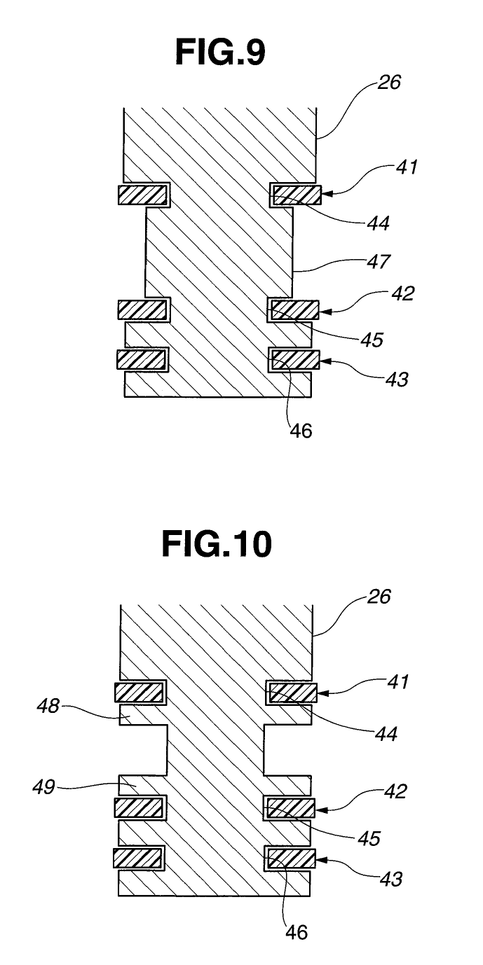

Moreover, as can be seen in FIGS. 1 and 9, on an outer circumference surface of a top end side of the intake side supplying/drawing rod 26, first to third seal holding grooves 44, 45 and 46 to which substantially ring shaped three sealing members 41, 42 and 43 are fitted are formed by cutting. These first to third seal holding grooves 44˜46 are formed through the cutting process after the casting of the second cover unit 61. The first seal holding groove 44 and the second seal holding groove 45 are defined by a reduced diameter part 47 that is formed at a top end side middle portion of the intake side supplying/drawing rod 26. That is, this reduced diameter part 47 is formed as a separation wall between the first and second seal holding grooves 44 and 45. Movement in one direction of an axial direction of the first and second sealing members 41 and 42 is then limited by each end surface of the reduced diameter part 47. By employing this structure, as compared with a case where two separation walls 48 and 49 are formed between the first and second seal holding grooves 44 and 45 shown in FIG. 10, man-hour of the cutting and quantity of the cutting can be reduced, and the yields is increased and machining time is reduced. This gives rise to reduction in manufacturing costs of the second cover unit 61 also in manufacturing costs of the VTC cover 28. In addition, the entire length of the intake side supplying/drawing rod 26 can be shortened by this structure.

In the following description, a method of producing the VTC cover 28 will be explained with reference to the drawings.

The VTC cover 28 is produced mainly through the following first to third processes.

A first process is a process in which the first cover unit 60 is molded. A second process is a process in which the second cover unit 61 is molded. A third process is a process in which the VTC cover 28 is assembled by combining the second cover unit 61 with the first cover unit 60. Here, as mentioned above, each of the first and second cover units 60 and 61 is molded by the same die casting, and their producing methods are almost the same. Thus, in the following explanation, an explanation of the producing method of the first cover unit 60 will be omitted, and only the producing method of the second cover unit 61 will be explained.

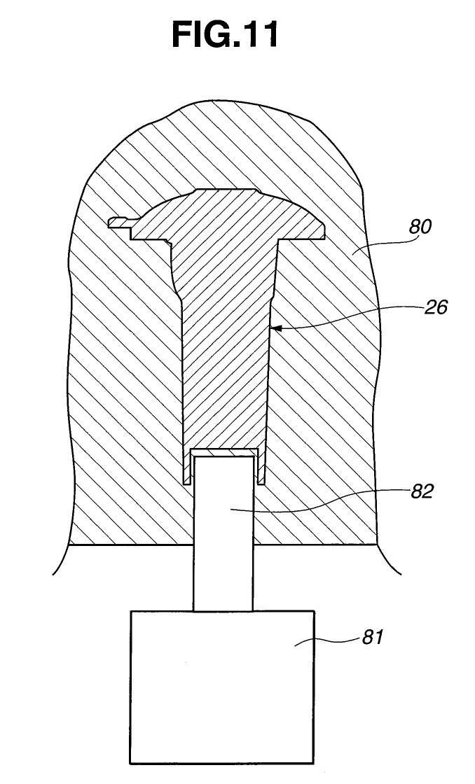

The second cover unit 61 is molded by a specified die-casting system. This die-casting system has, as shown in FIG. 11, a piston 81 that moves up and down by hydraulic pressure and a pressurizing pin 82 whose one end surface is fixed to the piston 81 and whose other end surface pressurizes a top end surface of the intake side supplying/drawing rod 26, then presses or penetrates a mold (a die) 80.

When molten metal is in semi-liquid (semi-solidified) state inside the mold 80, by moving the piston 81 upwards in the drawing, the top end surface of the intake side supplying/drawing rod 26 is pressurized by the pressurizing pin 82 moving together with the piston 81. The intake side supplying/drawing rod 26 is pressurized from its top end surface side in this manner, and is compacted by a load of the piston 81. With this, material (metal) of an inside of the intake side supplying/drawing rod 26 is densely or tightly compacted, and appearance of a cavity is suppressed.

Subsequently, using a specified cutting machine, the cutting processes are performed to the second cover unit 61 molded by the above die-casting, for forming the first to third seal holding grooves 44˜46 on the top end side outer circumference surface of the intake side supplying/drawing rod 26, the oil passages 28a and 28b, the guide surfaces 67a on the base end side etc. as shown in FIGS. 1, 6 and 9. By forming each guide surface 67a through the cutting process after the casting, the guide surfaces 67a can be formed with high accuracy, and this brings about an increase in accuracy of the positioning of the intake side supplying/drawing rod 26.

Next, the assembling of the VTC cover 28 is done. That is, the second cover unit 61 completed after the cutting processes is combined with the first cover unit 60 that is completed through the first process and the cutting processes. In this assembly, as shown in FIGS. 5 and 6, after the sealing member 71 is fitted in the seal holding groove 72 of the first cover unit 60, the intake side supplying/drawing rod 26 of the second cover unit 61 is inserted into the rod insertion hole 66 of the first cover unit 60. When inserting the base end portion of the intake side supplying/drawing rod 26 into the rod insertion hole 66, the positioning of the intake side supplying/drawing rod 26 with respect to the first cover unit 60 (the rod insertion hole 66) is done by each guide surface 67a. After completion of this positioning, the second cover unit 61 is fixed to the first cover unit 60 with the bolts 62, then the combined unit as the VTC cover 28 is completed.

As explained above, according to the present embodiment, the VTC cover 28 is formed by the first cover unit 60 and the second cover unit 61, each of which is separately formed. Thus, even in the case where both the VTCs 4 and 5 are arranged close to each other like the present embodiment, i.e. even in the case where both the intake side and exhaust side supplying/drawing rods 26 and 126 are required to be arranged close to each other, since each of the first and second cover units 60 and 61 can be molded and formed by the different system and the different process, there is no restriction or limitation on the pressurization of the cover units 60 and 61. Also the piston 81 having an optimum pressurization capability (an outside diameter) can be used for each casting system. With this, it is possible to compact and mold each of the cover units 60 and 61 with the sufficient pressurization. Consequently, the appearance of the cavity in the first and second cover units 60 and 61 can be suppressed. Also the appearance of the cavity in the VTC cover 28 as a whole can be suppressed.

Here, regarding the pressurization, in the case where an pressure-receiving area of the piston 81 is not enlarged but only pressure is increased, high pressure generator is required, and introduction of a costly system is needed. However, since the VTC cover 28 is formed by the first cover unit 60 and the second cover unit 61 and the first and second cover units 60 and 61 are molded by the different systems, the pressure-receiving area of the piston 81 can be freely set. Therefore, in the production of the VTC cover 28, increase in the production cost can be suppressed without depending on the above costly system to generate high pressure.

Further, since the VTC cover 28 is formed by the first cover unit 60 and the second cover unit 61, volume per one cover becomes small. Thus, as compared with a case where the VTC cover 28 is integrally molded, the appearance of the cavity can be effectively suppressed.

In particular, in the present embodiment, the exhaust side VTC 5 is set with the exhaust side VTC 5 shifting towards the VTC cover 28 with respect to the intake side VTC 4. Thus, when separating the VTC cover 28 into the first and second cover units 60 and 61, the volumes of the first and second cover units 60 and 61 are set so that, the volume of the first cover unit 60 covering the exhaust side VTC 5 side arranged close to the VTC cover 28 is set to be greater, and the volume of the second cover unit 61 covering the intake side VTC 4 side arranged apart from the VTC cover 28 is set to be relatively smaller. With this setting, the short axial length exhaust side supplying/drawing rod 126 can be formed at the first cover unit 60 having the greater volume, while the long axial length intake side supplying/drawing rod 26 can be formed at the second cover unit 61 having the smaller volume. With respect to the first cover unit 60 having the greater volume, since the axial length of the exhaust side supplying/drawing rod 126 is short, sufficient pressurization can be done throughout the whole first cover unit 60. As for the second cover unit 61 provided with the long axial length intake side supplying/drawing rod 26, since the volume of the second cover unit 61 is small, sufficient pressurization of the intake side supplying/drawing rod 26 can be done. As a consequence, the appearance of the cavity in the first and second cover units 60 and 61 can be effectively suppressed. Also the appearance of the cavity in the VTC cover 28 as a whole can be effectively suppressed.

Furthermore, since the first and second cover units 60 and 61 are molded by the different systems, as compared with a case these cover units 60 and 61 are molded as an integrally-formed cover, volume (quantity) of the molten metal used at one casting process can be reduced. Hence, occurrence of poor or bad flow of the molten metal can be suppressed, and the yields can be increased.

Moreover, since the first and second cover units 60 and 61 are molded by the different systems, even if a malfunction occurs in one casting system, the other casting system works without failure. Thus an influence by the malfunction can be reduced.

The present invention is not limited to the above embodiment. For example, shape or configuration of the first cover unit 60, the second cover unit 61 and the oil passage formed inside the cover could be freely changed according to specifications of the VTCs 4 and 5 and the internal combustion engine.

In addition, with respect to the protruding portions 67, the number of protruding portions should be at least three. Preferably, four or more protruding portions 67 are provided. In this case, more exact positioning of the intake side supplying/drawing rod 26 can be achieved.

From the foregoing, the present invention has the following effects.

A variable valve timing control apparatus (VTC) cover for covering both intake side and exhaust side VTCs 4 and 5 respectively controlling valve timing of an intake valve and an exhaust valve by supplying/drawing of oil, the intake side and exhaust side VTCs 4 and 5 arranged parallel to each other and installed to an internal combustion engine, the VTC cover comprises: a first cover unit 60 having a first supplying/drawing rod 126 inserted into a rod connecting hole 127 of one of the intake side and exhaust side VTCs 4 and 5 to supplies/draws the oil; and a second cover unit 61 having a second supplying/drawing rod 26 inserted into a rod connecting hole 27 of the other of the intake side and exhaust side VTCs 4 and 5 to supplies/draws the oil, and the VTC cover is formed by fixing the second cover unit 61 to the first cover unit 60.

Since the VTC cover 28 is formed by the first cover unit 60 and the second cover unit 61, each of which is separately formed, the first and second cover units 60 and 61 can be individually molded, and it is possible to compact each of the cover units 60 and 61 with the sufficient pressurization. As a consequence, in the case where the first and second supplying/drawing rods 126 and 26 are arranged close to each other, the appearance of the cavity in the VTC cover 28 as a whole can be suppressed.

In the present invention, the first cover unit 60 is provided with a rod insertion hole 66 into which the second supplying/drawing rod 26 is inserted upon the fixing of the second cover unit 61 to the first cover unit 60, and the second supplying/drawing rod 26 is provided with, at an outer circumference surface thereof, a positioning structure 67 that achieves positioning in a radial direction of the second supplying/drawing rod 26 with respect to the rod insertion hole 66.

When the second cover unit 61 is fixed to the first cover unit 60, by only inserting the second supplying/drawing rod 26 into the rod insertion hole 66, positioning of the second supplying/drawing rod 26 with respect to the first cover unit 60 can be automatically achieved. Thus efficiency in assembly of the VTC cover 28 by fixing the second cover unit 61 to the first cover unit 60 can be improved.

In the present invention, sealing members 71 and 73 are fitted between the first cover unit 60 and the second cover unit 61 to ensure liquid-tightness between the first and second cover units 60 and 61.

Since the liquid-tightness between the first and second cover units 60 and 61 is ensured, oil leakage from a connecting gap between both cover units can be suppressed.

In the present invention, the second cover unit 61 is fixed to the first cover unit 60 with a plurality of bolts 62.

With this, the first cover unit 60 and the second cover unit 61 can be detached from each other, also can be firmly fixed to each other.

In the present invention, the one of the intake side and exhaust side VTCs 4 and 5 is offset with respect to the other of the VTCs 4 and 5 so as to protrude toward a VTC cover side, and the first cover unit 60 is provided with the first supplying/drawing rod 126 for supplying/drawing the oil to/from the one VTC 5 protruding toward the VTC cover side.

With this, although the volume of the first cover unit 60, as a base body of the VTC cover 28, becomes large, since an axial length of the first supplying/drawing rod 126 is shorter, sufficient pressurization can be done throughout the whole first cover unit 60. On the other hand, as for the second cover unit 61, even though the an axial length of the second supplying/drawing rod 26 is longer, since the volume of the second cover unit 61 is small, sufficient pressurization of the second supplying/drawing rod 26 and the second cover unit 61 can be done. As a consequence, the appearance of the cavity in the first and second cover units 60 and 61 can be effectively suppressed. Also the appearance of the cavity in the VTC cover 28 as a whole can be effectively suppressed.

In the present invention, the VTC cover is configured so that positions of both supplying/drawing rod base ends in the respective axial directions of the first and second supplying/drawing rods 126 and 26 are the same upon the fixing of the second cover unit 61 to the first cover unit 60.

With this configuration, it is possible to prevent an unnecessarily large uneven part from being formed on an outside of the VTC cover 28. This allows an improvement in layout design of the internal combustion engine.

In the present invention, the first cover unit 60 is provided with the first supplying/drawing rod 126 that supplies/draws the oil to/from the exhaust side VTC 5. Further, the intake side and exhaust side VTCs 4 and 5 are installed to the engine so that rotation of an engine crankshaft is transmitted to the intake side VTC 4 and rotation of the intake side VTC 4 is then transmitted to the exhaust side VTC 5.

In order for the intake side VTC 4 to receive rotation from the engine crankshaft, the chain is wound around the drive input sprocket of the intake side VTC 4. Further, in order that the exhaust side VTC 5 is not in contact with the chain, the exhaust side VTC 5 is set with the exhaust side VTC 5 shifting towards the VTC cover 28 with respect to the intake side VTC 4. With these configurations, the length of the first supplying/drawing rod 126 of the first cover unit 60 is set to be relatively short. Therefore, the same effect as the above can be obtained. That is, although the volume of the first cover unit 60 is large, since the axial length of the first supplying/drawing rod 126 is shorter, sufficient pressurization can be done throughout the whole first cover unit 60.

In the present invention, the second cover unit 61 is fixed to the first cover unit 60, and the first cover unit 60 is fixed to the engine.

With this, efficiency in installation of the VTC cover 28 to the engine can be improved.

In the present invention, the positioning structure is formed by a plurality of protruding portions 67 which are arranged on an outer circumference surface of the second supplying/drawing rod 26 and protrude along the radial direction of the second supplying/drawing rod 26.

Since the protruding portions 67 are integrally formed when the second cover unit 61 is produced, the positioning structure or mechanism can be readily provided.

In the present invention, the each protruding portion 67 is provided with, on a top surface thereof, a guide surface 67a through a cutting process, and the guide surface 67a is formed at least a predetermined area on the top surface which is positioned in an opposed position to an inner circumference surface of the rod insertion hole 66 and makes contact with the inner circumference surface upon the fixing of the second cover unit 61 to the first cover unit 60.

Since the guide surface 67a is formed through the cutting process, the guide surface 67a can be accurately formed, and more exact positioning of the second supplying/drawing rod 26 can be achieved.

In the present invention, the positioning structure is formed by at least three protruding portions 67.

With this, accurate and stable positioning in the radial direction of the second supplying/drawing rod 26 can be achieved.

A method for producing a variable valve timing control apparatus (VTC) cover for covering both intake side and exhaust side VTCs 4 and 5 respectively controlling valve timing of an intake valve and an exhaust valve by supplying/drawing of oil through first and second supplying/drawing rods 126 and 26, the intake side and exhaust side VTCs 4 and 5 arranged parallel to each other and installed to an internal combustion engine, the method comprises: a first process in which a first cover unit 60 is molded by pressurizing a top portion of the first supplying/drawing rod 126 through a die casting; a second process in which a second cover unit 61 is molded by pressurizing a top portion of the second supplying/drawing rod 26 through a die casting; and a third process in which the second cover unit 61 is fixed to the first cover unit 60.

Since the VTC cover 28 is formed by the first cover unit 60 and the second cover unit 61, each of which is separately formed then the first and second cover units 60 and 61 are individually molded, in the case where the first and second supplying/drawing rods 126 and 26 are arranged close to each other, it is possible to compact each of the cover units 60 and 61 with the sufficient pressurization, and the appearance of the cavity in the VTC cover 28 as a whole can be suppressed.

The entire contents of Japanese Patent Application No. 2009-283641 filed on Dec. 15, 2009 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A variable valve timing control apparatus (VTC) cover for covering both intake side and exhaust side VTCs respectively controlling valve timing of an intake valve and an exhaust valve by supplying/drawing of oil, the intake side and exhaust side VTCs arranged parallel to each other and installed to an internal combustion engine, the VTC cover comprising:
a first cover unit having a first supplying/drawing rod inserted into a rod connecting hole of one of the intake side and exhaust side VTCs to supplies/draws the oil; and
a second cover unit having a second supplying/drawing rod inserted into a rod connecting hole of the other of the intake side and exhaust side VTCs to supplies/draws the oil, and
the VTC cover being formed by fixing the second cover unit to the first cover unit.

2. The VTC cover as claimed in claim 1, wherein:
the first cover unit is provided with a rod insertion hole into which the second supplying/drawing rod is inserted upon the fixing of the second cover unit to the first cover unit, and
the second supplying/drawing rod is provided with, at an outer circumference surface thereof, a positioning structure that achieves positioning in a radial direction of the second supplying/drawing rod with respect to the rod insertion hole.

3. The VTC cover as claimed in claim 1, wherein:
a sealing member is fitted between the first cover unit and the second cover unit to ensure liquid-tightness between the first and second cover units.

4. The VTC cover as claimed in claim 3, wherein:
the second cover unit is fixed to the first cover unit with a plurality of bolts.

5. The VTC cover as claimed in claim 4, wherein:
the one of the intake side and exhaust side VTCs is offset with respect to the other of the VTCs so as to protrude toward a VTC cover side, and
the first cover unit is provided with the first supplying/drawing rod for supplying/drawing the oil to/from the one VTC protruding toward the VTC cover side.

6. The VTC cover as claimed in claim 5, wherein:
the VTC cover is configured so that positions of both supplying/drawing rod base ends in the respective axial directions of the first and second supplying/drawing rods are the same upon the fixing of the second cover unit to the first cover unit.

7. The VTC cover as claimed in claim 5, wherein:
the first cover unit is provided with the first supplying/drawing rod that supplies/draws the oil to/from the exhaust side VTC.

8. The VTC cover as claimed in claim 7, wherein:
the intake side and exhaust side VTCs are installed to the engine so that rotation of an engine crankshaft is transmitted to the intake side VTC and rotation of the intake side VTC is then transmitted to the exhaust side VTC.

9. The VTC cover as claimed in claim 1, wherein:
the second cover unit is fixed to the first cover unit, and
the first cover unit is fixed to the engine.

10. The VTC cover as claimed in claim 2, wherein:
the positioning structure is formed by a plurality of protruding portions which are arranged on an outer circumference surface of the second supplying/drawing rod and protrude along the radial direction of the second supplying/drawing rod.

11. The VTC cover as claimed in claim 10, wherein:
the each protruding portion is provided with, on a top surface thereof, a guide surface through a cutting process, and
the guide surface is formed at least a predetermined area on the top surface which is positioned in an opposed position to an inner circumference surface of the rod insertion hole and makes contact with the inner circumference surface upon the fixing of the second cover unit to the first cover unit.

12. The VTC cover as claimed in claim 10, wherein:
the positioning structure is formed by at least three protruding portions.

13. The VTC cover as claimed in claim 1, wherein:
the first cover unit and the second cover unit are made of aluminum alloy material.

14. The VTC cover as claimed in claim 1, wherein:
the first cover unit and the second cover unit are formed so that volume of the first cover unit is greater than that of the second cover unit,
the first cover unit is provided with the first supplying/drawing rod whose axial length is shorter than the second supplying/drawing rod, and
the second cover unit is provided with the second supplying/drawing rod whose axial length is longer than the first supplying/drawing rod.

15. A method for producing a variable valve timing control apparatus (VTC) cover for covering both intake side and exhaust side VTCs respectively controlling valve timing of an intake valve and an exhaust valve by supplying/drawing of oil through first and second supplying/drawing rods, the intake side and exhaust side VTCs arranged parallel to each other and installed to an internal combustion engine, the method comprising:
a first process in which a first cover unit is molded by pressurizing a top portion of the first supplying/drawing rod through a die casting;
a second process in which a second cover unit is molded by pressurizing a top portion of the second supplying/drawing rod through a die casting; and
a third process in which the second cover unit is fixed to the first cover unit.

16. The method for producing the VTC cover as claimed in claim 15, wherein:
the first cover unit and the second cover unit are made of aluminum alloy material, and
the first and second cover units are molded through the respective aluminum die casting processes.
